(19) United States
(12) Patent Application Publication
(10) Pub. No.: US 2018/0046505 A1
(43) Pub. Date: Feb. 15, 2018

(54) PARALLEL PROCESSING APPARATUS AND JOB MANAGEMENT METHOD

(71) Applicant: FUJITSU LIMITED, Kawasaki-shi (JP)

(72) Inventor: Kazushige Saga, Taito (JP)

(73) Assignee: FUJITSU LIMITED, Kawasaki-shi (JP)

(21) Appl. No.: 15/671,669

(22) Filed: Aug. 8, 2017

(30) Foreign Application Priority Data
Aug. 12, 2016 (JP) 2016-158758

(51) Int. Cl. G06F 9/48; G06F 9/46

(52) U.S. Cl. CPC G06F 9/4881; G06F 9/461; G06F 1/3287

(57) ABSTRACT

A parallel processing apparatus includes a plurality of calculation processors configured to execute a job, a memory configured to store information of an executed job before a target job is submitted, an execution exit code of the executed job, the target job, a submitted job before the target job is submitted, and a time difference between a timing of an immediately preceding event of the target job and a timing of submitting the target job, and a management processor coupled to the memory and configured to predict a period to a timing of submitting a next job and a necessity number of the calculation processors for calculating the next job by machine learning mechanism on the basis of the information stored in the memory when an event occurs, and control each of the calculation processors in accordance with the predicted period and the necessity number of the calculation processors.

### CROSS-REFERENCE TO RELATED APPLICATION

This application is based upon and claims the benefit of priority of the prior Japanese Patent Application No. 2016-158758, filed on Aug. 12, 2016, the entire contents of which are incorporated herein by reference.

### FIELD

The embodiments discussed herein are related to a parallel processing apparatus and a job management method.

### BACKGROUND

A parallel processing apparatus to perform processing by using a plurality of calculation processors is used. The calculation processors each function as a processing unit to perform information processing. The calculation processors each include a central processing unit (CPU), a random access memory (RAM), and so forth, for example. The parallel processing apparatus may include a large number of calculation processors. Therefore, processing operations (jobs) are not currently performed in all the calculation processors, and there are calculation processor not currently used. Therefore, it is under consideration that some of the calculation processor not currently used are each put into a power-off or suspended state, thereby achieving low power consumption.

There is a proposal for using a machine learning function called a neural network, thereby achieving low power consumption of an electronic apparatus, for example. In this proposal, the neural network is trained so as to recognize an operation performed by a kernel of an operating system (OS). After that, in a case where an audio reproducing function is executed for a music file stored in a Secure Digital (SD) card, the neural network recognize execution of this function, based on an instruction pattern executed by the kernel, for example. In addition, the neural network transmits, to an electric power management system, a command to reduce or disconnect power supply to Wireless Fidelity (WiFi: registered trademark) or a graphics (Gfx) subsystem that is not used for the audio reproducing function.

In addition, there is a proposal in which, in a high performance computing (HPC) system, a job to lose no performance (or to have an acceptable performance loss) in a case of being executed in an energy preservation mode is identified and performance is maintained for the relevant job, thereby saving energy.

Examples of the related art are disclosed in Japanese Laid-open Patent Publication No. 2011-210265 and Japanese Laid-open Patent Publication No. 2015-118705.

### SUMMARY

According to an aspect of the invention, a parallel processing apparatus includes a plurality of calculation processors configured to execute a plurality of jobs, a memory configured to store information of an executed job before a target job is submitted, an execution exit code of the executed job, the target job, a submitted job before the target job is submitted, and a time difference between a timing of an immediately preceding event of the target job and a timing of submitting the target job, and a management processor coupled to the memory and configured to predict a period to a timing of submitting a next job and a necessity number of the calculation processors for calculating the next job by machine learning mechanism on the basis of the information stored in the memory when an event occurs, and control each of the calculation processors in accordance with the predicted period and the necessity number of the calculation processors.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a parallel processing apparatus of a first embodiment;

FIG. 2 is a diagram illustrating an example of a calculation system of a second embodiment;

FIG. 3 is a diagram illustrating an example of hardware of a management and calculation processor;

FIG. 4 is a diagram illustrating an example of hardware of a file server;

FIG. 5 is a diagram illustrating an example of a function of the management and calculation processor;

FIG. 6 is a diagram illustrating an example of a neural network;

FIG. 7 is a diagram illustrating examples of power activation of calculation processors and execution of jobs;

FIG. 8 is a flowchart illustrating an example of processing performed by the management and calculation processor;

FIG. 9 is a flowchart illustrating an example of learning;

FIG. 10 is a flowchart illustrating the example of the learning (continued);

FIG. 11 is a flowchart illustrating an example of a prediction of demand for calculation processors;

FIG. 12 is a flowchart illustrating an example of a re-energization operation; and

FIGS. 13A and 13B are diagrams each illustrating an example of activation of calculation processors.

### DESCRIPTION OF EMBODIMENTS

In a case where some calculation processors are powered off or suspended in order to achieve low power consumption, there is a problem that, as a side effect thereof, it becomes difficult to immediately use calculation processors at a desired timing to perform calculation, or the like. In a computer system, there are many operations in each of which a user submits a job at a desired timing. Therefore, in general when a job is to be submitted and what kind of job is to be submitted are unclear. Therefore, an operation in which calculation processors are powered on at a timing at which the user intends to execute jobs is conceivable, for example. However, it takes a time for the calculation processors to be put into states of being able to receive jobs after starting being powered on, and a start of execution of jobs is delayed. This problem causes a job throughput to be reduced or causes a usage efficiency of a calculation processor to be reduced. In one aspect, an object of the present technology is to enable execution of jobs to be swiftly started. Hereinafter, the present embodiments will be described with reference to drawings.

### First Embodiment

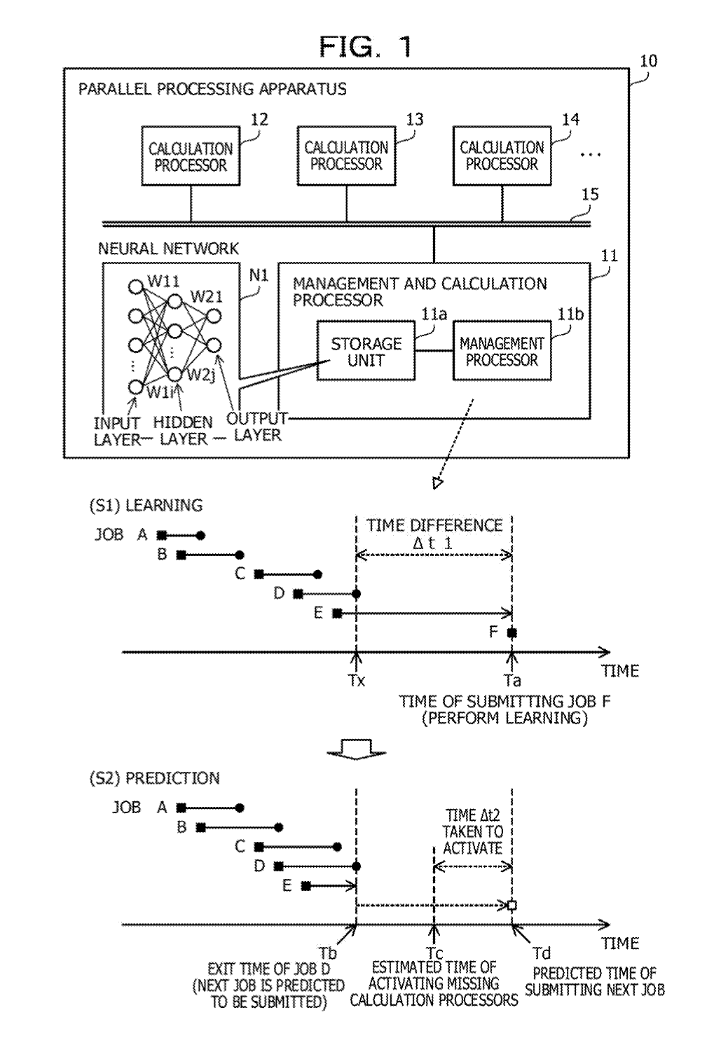

FIG. 1 is a diagram illustrating a parallel processing apparatus of a first embodiment. A parallel processing apparatus 10 includes a management and calculation processor 11 and calculation processor 12, 13, 14, . . . In addition, the parallel processing apparatus 10 includes a network 15. The management and calculation processor 11 and the calculation processor 12,13,14, . . . are coupled to the network 15. The network 15 is an internal network of the parallel processing apparatus 10. The management and calculation processor 11 is a processor to manage jobs executed by the calculation processors 12, 13, 14, . . . . The calculation processors 12, 13, 14, . . . are calculation processors used for calculation processing for executing jobs in parallel. The parallel processing apparatus 10 may execute one job by using some of the calculation processors 12, 13, 14, . . . or may execute other jobs in parallel by using some of other calculation processors.

Here, all the calculation processors 12, 13, 14, . . . are not continuously powered on. Some of the calculation processors may be powered on and some of other calculation processors may be powered off. The parallel processing apparatus 10 powers off (or suspends) calculation processors none of which are used for job execution during a predetermined time period after previous job execution, thereby achieving low power consumption, for example.

The management and calculation processor 11 includes a storage unit 11a and a management processor 11b. The storage unit 11a may be a volatile storage apparatus such as a RAM or may be a non-volatile storage apparatus such as a flash memory. The management processor 11b is a processor, for example. The processor may be a CPU or a digital signal processor (DSP) or may include an integrated circuit such as an application specific integrated circuit (ASIC) or a field programmable gate array (FPGA). The processor executes a program stored in the RAM, for example. In addition, the “processor” may be a set of two or more processors (multiprocessor). In addition, in the same way as the management and calculation processor 11, the calculation processors 12, 13, 14, . . . each include a storage unit (a RAM, for example) and a management processor (a processor such as a CPU, for example). The management and calculation processor 11 and the calculation processors 12, 13, 14, . . . may be each called a “computer”.

The storage unit 11a stores therein information used for control based on the management processor 11b. The storage unit 11a stores therein an event log in the parallel processing apparatus 10. The event log includes a login history and a job history of a user. The login history includes identification information of a user and pieces of information of a time when the user logs in and a time when the user logs out. The job history includes identification information of a job and pieces of information such as a user who requests execution of the job, log types including submitting, execution start, execution completion, and so forth of the job, times of the submitting, execution start, and execution completion of the job, and an execution exit code of the job. The identification information of the job may be a hash value of an object program to be executed as the job. In addition, the storage unit 11a stores therein learning data of execution states of jobs, based on the management processor 11b, activation schedules of calculation processors, based on the management processor 11b, and so forth.

The management processor 11b performs learning of execution states of jobs, a prediction of demand for calculation processors, based on a learning result, and controlling of activation states of the respective calculation processors, which corresponds to the demand prediction. Here, the management processor 11b learns the execution states of the jobs by using a machine learning mechanism. The management processor 11b learns the execution states of the jobs by using a neural network N1 as an example of the machine learning mechanism. The neural network N1 is a learning function that simulates a mechanism of signal transmission based on neuronal cells (neurons) existing in a brain. The neural network is also called a neural net in some cases.

The management processor 11b stores, in the storage unit 11a, information related to the neural network N1. The neural network N1 includes an input layer, a hidden layer, and an output layer. The input layer is a layer to which a plurality of elements corresponding to inputs belong. The hidden layer is a layer located between the input layer and the output layer, and one or more hidden layers exist. Arithmetic results based on predetermined functions (including coupling factors described later) corresponding to pieces of input data from the input layer belong, as elements, to the hidden layer (the relevant arithmetic results become inputs to the output layer). The output layer is a layer to which a plurality of elements corresponding to outputs of the neural network Ni belong.

In the learning based on the neural network N1, coupling factors between elements belonging to different layers are determined. Specifically, the management processor 11b determines, based on supervised learning, coupling factors W11, W12, . . . , W1i between respective elements of the input layer and respective elements of the hidden layer and coupling factors W21, W22, . . . , W2j between respective elements of the hidden layer and respective elements of the output layer and stores these in the storage unit 11a. Here, “i” is an integer and is the number of coupling factors that are included in respective functions of converting from the input layer to the hidden layer and that correspond to respective data elements of the input layer. “j” is an integer and is the number of coupling factors that are included in respective functions of converting from the hidden layer to the output layer and that correspond to respective data elements of the hidden layer.

At a timing of submitting jobs to the calculation processors 12, 13, 14, . . . (alternatively, some of the calculation processors), the management processor 11b acquires information of jobs executed before the timing of the submitting, execution exit codes of the executed jobs, and information of a submit target job and other submitted jobs. Here, the information of executed jobs is identification information of a predetermined number of jobs executed before the timing of the submitting. The information of the executed jobs may be identification information of jobs executed within a predetermined time period before the timing of the submitting. The execution exit codes of the executed jobs are exit codes of the predetermined number of executed jobs (or jobs executed within the predetermined time period). The information of the other submitted jobs is identification information of jobs already submitted at a timing of submitting a job serving as the submit target job, for example. The information of the submit target job is the number of calculation processors to be used by the submit target job. The information of the executed jobs, the execution exit codes of the executed jobs, and the information of the other submitted jobs become information for recognizing an order of submitting jobs in accordance with a procedure of a user's work (types of jobs and a dependency relationship therebetween). Note that the execution exit codes of the executed jobs become information for recognizing that the flow of the work is changed by execution results of jobs and jobs to be submitted are changed. In addition, at the timing of submitting the relevant job, the management processor 11b acquires a time difference between a timing of an occurrence of an immediately preceding event and the timing of the submitting. As an event on which attention is focused, a login of a user or execution exit of a job is conceivable, for example. By referencing the event log stored in the storage unit 11a, the management processor 11b is able to acquire these pieces of information, for example. In addition, upon receiving an instruction to submit the submit target job, the management processor 11b receives an instruction for the number of calculation processors to be used by the submit target job, in some cases. In this case, the management processor 11b is able to obtain the number of calculation processors to be used by the submit target job, based on a content of the relevant instruction.

Based on acquired various kinds of information, the management processor 11b learns, by using the neural network N1, a time period before submitting of a job to be submitted after the occurrence of a corresponding event and a necessity number of calculation processors of the relevant job. Input-side teacher data (corresponding to the individual elements of the input layer) corresponds to the identification information of the executed jobs, the execution exit codes of the executed jobs, and the identification information of the other submitted jobs, for example. The input-side teacher data may further include information indicating a time of occurrence of an immediately preceding event. Output-side teacher data (corresponding to the individual elements of the output layer) corresponds to a time difference between a timing of an occurrence of the relevant event and the timing of this submitting and the number of calculation processors to be used by this submit target job (a necessity number of calculation processors).

Step S1 in FIG. 1 exemplifies a case where jobs A, B, C, D, and E are executed in order and a job F is submitted at a time Ta. In an example of FIG. 1, a right side in the direction of a paper surface corresponds to a positive time direction. In addition, timings at which jobs are submitted are expressed by black quadrangles, and timings at which execution of jobs is completed are expressed by black circles. Here, submitting of a job corresponds to a timing at which a user requests to execute the job, and in the HPC system, in general start of the execution is forced to wait, depending on the availability of resources such as calculation processors. Therefore, the job is not executed at the timing of being submitted, in some cases. In other words, line segments connecting the black quadrangles with the black circles each correspond to a time period during which execution of a corresponding one of jobs is forced to wait and a time period during which the corresponding one of jobs is executed. An arrow that extends from one of the black quadrangles to a time indicates that the relevant job is forced to wait or is executed in a time period from a time indicated by the corresponding one of the black quadrangles to a time at the tip of the arrow and that the relevant job waits for being executed or is currently executed at the time at the tip of the arrow.

It may be said that the submitting of the job F is one event in the parallel processing apparatus 10. In this case, the management processor 11b performs the above-mentioned learning. At the time Ta, the execution of the jobs A, B, C, and D is completed. Therefore, the jobs A, B, C, and D are executed job at the time Ta. The job E waits for being executed or is currently executed at the time Ta. Therefore, the job E is a submitted job at the time Ta.

The management processor 11b acquires, from the event log, pieces of identification information of a predetermined number (four, for example) of the respective executed jobs A, B, C, and D preceding the time Ta (the timing of submitting the job F) and the most recent execution exit codes of the respective executed jobs A, B, C, and D. In addition, the management processor 11b acquires, from the event log, identification information of the submitted job E at the time Ta. From a content of an instruction at the timing of submitting the job F, the management processor 11b acquires the number of calculation processors to be used by the job F. Furthermore, the management processor 11b acquires, from the event log, a time Tx of occurrence of an event immediately preceding the submitting of the job F. The immediately preceding event is execution exit of the job D, and the time Tx is an execution exit time of the job D. The management processor 11b acquires a time difference AU between the time Ta and the time Tx.

The management processor 11b defines, as the input-side teacher data of the neural network N1, the pieces of identification information of the respective executed jobs A, B, C, and D, the execution exit codes of the respective executed jobs A, B, C, and D, and the identification information of the submitted job E. In addition, the management processor 11b defines, as the output-side teacher data, a necessity number of calculation processors of the job F and the time difference Δt1. In addition, based on, for example, a supervised learning method such as a back propagation method, the management processor 11b updates the coupling factors W11, W12, . . . , W1i and W21, W22, . . . , W2j of the neural network N1. The management processor 11b repeats the above-mentioned learning, thereby adjusting the individual coupling factors to actual execution states of jobs.

After that, by using a learning result based on the neural network N1, for an occurrence of an event (a login of a user, execution exit of a job, or the like, for example), the management processor 11b predicts a time period before submitting of a next job and a necessity number of calculation processors of the relevant next job.

Step S2 in FIG. 1 exemplifies a prediction of demand for calculation processors, performed by the management processor 11b in a case where execution of the job D is exited at a time Tb. At the time Tb, execution of the jobs A, B, C, and D is completed. Therefore, the jobs A, B, C, and D are executed job at the time Tb. The job E waits for being executed or is currently executed at the time Tb. Therefore, the job E is a submitted job at the time Ta.

The management processor 11b acquires, from the event log, pieces of identification information of a predetermined number (four, for example) of the respective executed jobs A, B, C, and D preceding the time Tb and the most recent execution exit codes of the respective executed jobs. In addition, the management processor 11b acquires, from the event log, identification information of the submitted job E at the time Tb. The management processor 11b inputs the acquired individual pieces of information to the neural network N1 and calculates values of the respective elements of the output layer, thereby predicting a time Td at which a next job is to be submitted (a predicted time of submitting the next job) and a necessity number of calculation processors of the next job. A white quadrangle indicated at the time Td in FIG. 1 indicates the predicted time of submitting the next job.

In addition, based on the predicted time Td of submitting the next job and the necessity number of calculation processors, predicted in this way by using a learning result based on the neural network N1, the management processor 11b controls activation states of the respective calculation processors.

Specifically, first, for the necessity number of calculation processors of the next job, the management processor 11b obtains the number of missing calculation processors caused by being powered off (missing calculation processors). In addition, the management processor 11b determines an estimated time Tc of activating the missing calculation processors so as to be ready in time for the predicted time Td of submitting. In order to determine the estimated time Tc of activation, the management processor 11b considers a time Δt2 taken to activate the missing calculation processors (a time taken to activate). It is assumed that, due to limitation of power consumption (an upper limit of power consumption), the number of calculation processors able to simultaneously start being powered on is “N” and the number of the missing calculation processors is “M”, for example. In addition, it is assumed that a time taken to activate one calculation processor is τ. Then, the time Δt2=ROUNDUP(M/N)×τ is satisfied, for example. Here, the ROUNDUP function is a function of rounding up to the nearest whole number.

The management processor 11b defines, as the estimated time Tc of activating the missing calculation processors, a time earlier than the predicted time Td of submitting by the time Δt2 taken to activate, for example. Alternatively, the management processor 11b may define, as the estimated time Tc of activating the missing calculation processors, a time earlier than the predicted time Td of submitting by Δt2+α (α is a predetermined time period). The management processor 11b stores, in the storage unit 11a, an activation schedule of the missing calculation processors. In addition, when the estimated time Tc of activation arrives, the management processor 11b powers on calculation processors corresponding to the missing calculation processors and prepares to submit a next job.

Note that, in a case where there are a plurality of users who use the processing apparatus 10, the management processor 11b may learn and predict demand for calculation processors for each of the users. In that case, the management processor 11b prepares the neural network N1 for each of the users and narrows down to a login of a corresponding one of the users or a job requested by the corresponding one of the users, thereby learning and predicting demand for calculation processors.

In this way, the parallel processing apparatus 10 enables the execution of the next job to be swiftly started.

Here, in a case where some calculation processors are powered off or suspended for low power consumption, as a side effect thereof, there is a problem that it becomes difficult to immediately use calculation processors at a timing desired for performing calculation, or the like. In the parallel processing apparatus 10, there are many operations in each of which a user submits a job at a desired timing. Therefore, in many cases, when a job is to be submitted and what kind of job is to be submitted are unclear. An operation in which some calculation processors are powered on at a timing at which the user intends to execute a job is conceivable, for example. However, it takes a time for the calculation processors to be completely powered on after starting being powered on, and the start of execution of the job is delayed. This problem causes a job throughput to be reduced or causes a usage efficiency of a calculation processor to be reduced.

Therefore, at a timing of submitting a job, the parallel processing apparatus 10 learns execution states of jobs by using the neural network N1. Specifically, the management and calculation processor 11 defines, as the input-side teacher data, identification information of a most recently exited job, an exit code of the relevant job, and identification information of other submitted jobs. In addition, the management and calculation processor 11 defines, as the output-side teacher data, a time difference (relative time) between an event such as previous exiting of a job and the submitting of this job and a necessity number of calculation processors of this job. The reason is that logins, execution states of previous jobs, execution exit codes thereof, and current execution states of jobs are considered to be related to the submitting of this job.

By using a learning result obtained in this way, the management and calculation processor 11 is able to roughly predict a necessity number of calculation processors of the next job and a submitting timing thereof. Therefore, even in a case where a necessity number of calculation processors is insufficient due to powered-off calculation processors, the management and calculation processor 11 is able to put calculation processors corresponding to the necessity number of calculation processors into states of being able to receive jobs or states close thereto (the middle of being booted) at the predicted submitting timing. After a login of a user, the management and calculation processor 11 is able to predict the number of calculation processors desired for execution of a job of the relevant user and to preliminarily activate desired calculation processors before submitting the job, for example. In addition, after exiting of a job, in accordance with the exited job, it is possible to predict the number of calculation processors desired for execution of a next job and a time of submitting the next job, thereby using these for power management of calculation processors, and it is possible to preliminarily activate desired calculation processors before submitting the next job, for example.

In this way, the parallel processing apparatus 10 is able to enable execution of the next job to be swiftly started. As a result, while powering off (or suspending) free calculation processors, thereby reducing power consumption, the parallel processing apparatus 10 is able to suppress the reduction of a job throughput or the usage efficiency of resources.

### Second Embodiment

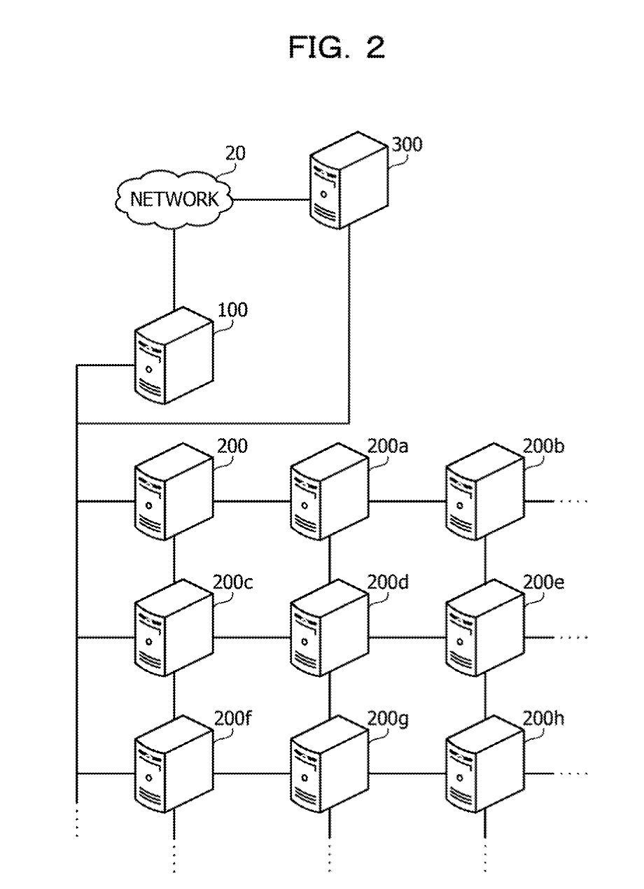

FIG. 2 is a diagram illustrating an example of a calculation system of a second embodiment. The calculation system of the second embodiment includes a large number (about several tens of thousands to a hundred thousand, for example) of calculation processors and executes jobs in parallel by using a plurality of calculation processors. In addition, the relevant calculation system may execute other jobs in parallel by using a plurality of other calculation processors.

The calculation system of the second embodiment includes a management and calculation processor 100 and calculation processors 200, 200a, 200b, 200c, 200d, 200e, 200f, 200g, 200h, . . . Here, in what follows, individual calculation processors of the calculation processors 200, 200a, 200b, 200c, 200d, 200e, 200f, 200g, 200h, . . . are called individual calculation processors so as to refer thereto, in some cases.

The management and calculation processor 100 and the individual calculation processors are coupled to an interconnection network called an interconnect and located within the calculation system. The form of the interconnection network is no object and may be a direct network called a mesh or a torus. In addition, the management and calculation processor 100, a file server 300, and the individual calculation processors are coupled to a management network within the calculation system.

The management and calculation processor 100 is coupled to a network 20. The file server 300 may be coupled to the network 20. The network 20 may be a local network located within a data center in which the calculation system is installed or may be a wide area network located outside the data center.

The management and calculation processor 100 is a server computer to manage a login to the calculation system, performed by a user, and execution operations for jobs, performed by the individual calculation processors. The management and calculation processor 100 receives a login performed by the user, from a client computer (an illustration thereof is omitted in FIG. 2) coupled to the network 20, for example. The user is able to input information (job information) of jobs serving as execution targets in the management and calculation processor 100. The job information includes contents of the jobs to be executed by the individual calculation processors and information of the number of calculation processors caused to execute the jobs. The user submits a job to a job management system on the management and calculation processor. At a timing of submitting the job, the user has to specify information of resources desired for execution, such as a path and arguments of a program to be executed as the job and the number of calculation processors desired for the execution.

The job management system in the management and calculation processor 100 schedules calculation processors to execute the submitted job (job scheduling), and in a case where the job becomes able to be executed by the scheduled calculation processors (execution of other jobs in the relevant calculation processors is exited, or the like), the job management system causes the relevant calculation processors (some of the calculation processors) to execute the job. In addition, the management and calculation processor 100 further manages power-supply states of the individual calculation processors. That includes a case where the total number of calculation processors desired for a jog group in execution falls below the number of calculation processors in the entire system, a case of a system adopting a mesh type or torus type as a network (interconnect) within the calculation system, a case where a network shape of free calculation processors and a network shape requested by a job are not matched with each other and free calculation processors difficult to use are generated (fragmentation), and so forth, for example. Therefore, the management and calculation processor 100 stops power supplies of such free calculation processors or puts the free calculation processors into suspended states, thereby achieving low power consumption. Note that a calculation processor (login calculation processor) to receive a login performed by a user may be installed separately from the management and calculation processor 100.

Each of the calculation processors 200 is a server computer to execute a job submitted by the management and calculation processor 100.

The file server 300 is a server computer to store therein various kinds of data. The server 300 is able to distribute, to the calculation processors 200, a program to be executed by the calculation processors 200, for example.

Here, the calculation system of the second embodiment is used by a plurality of users. In the relevant computer system, the users each submit a job at a desired timing, in many cases. Therefore, when a job is to be submitted and what kind of job is to be submitted are unclear. Therefore, the management and calculation processor 100 learns, based on execution states of jobs, demand for calculation processors and predicts demand for calculation processors by using a learning result, thereby providing a function of accelerating starting of execution of a job while achieving low power consumption.

The calculation system of the second embodiment is an example of the parallel processing apparatus 10 of the first embodiment. The management and calculation processor 100 is an example of the management and calculation processor 11 of the first embodiment.

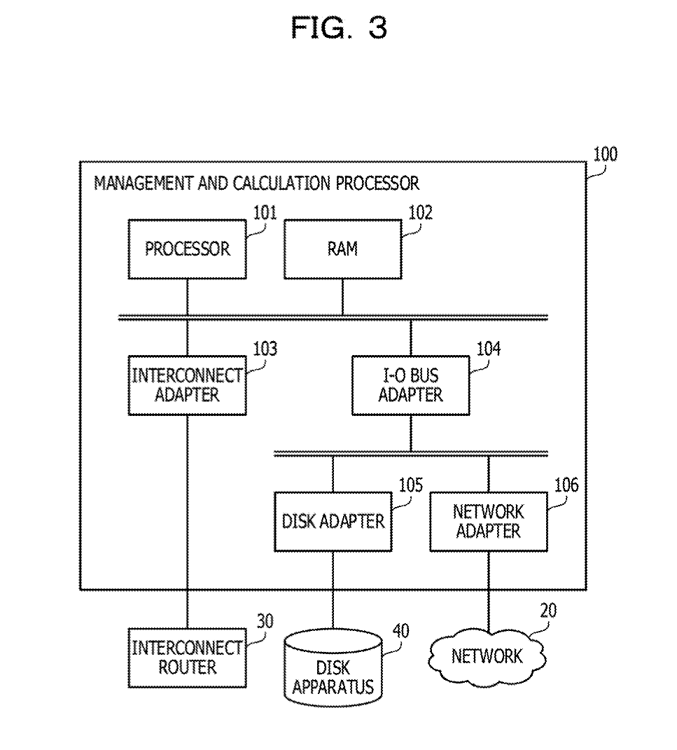

FIG. 3 is a diagram illustrating an example of hardware of a management and calculation processor. The management and calculation processor 100 includes a processor 101, a RAM 102, an interconnect adapter 103, an input-output (I-O) bus adapter 104, a disk adapter 105, and a network adapter 106.

The processor 101 is a management apparatus to control information processing performed by the management and calculation processor 100. The processor 101 may be a multiprocessor including a plurality of processing elements. The processor 101 is a CPU, for example. The processor 101 may be obtained by combining a DSP, an ASIC, an FPGA, and so forth with the CPU.

The RAM 102 is a main storage apparatus of the management and calculation processor 100. The RAM 102 temporarily stores therein at least some of an OS program and application programs that are to be executed by the processor 101. In addition, the RAM 102 stores therein various kinds of data to be used for processing performed by the processor 101.

The interconnect adapter 103 is a communication interface to be coupled to the interconnect. The interconnect adapter 103 is coupled to an interconnect router 30 belonging to the interconnect, for example.

The I-O bus adapter 104 is a coupling interface for coupling the disk adapter 105 and the network adapter 106.

The interconnect adapter 103 is coupled to the I-O bus adapter 104 in some cases.

The disk adapter 105 is coupled to the disk apparatus 40. The disk apparatus 40 is an auxiliary storage apparatus of the management and calculation processor 100. The disk apparatus 40 may be called a hard disk drive (HDD). The disk apparatus 40 stores therein the OS program, the application programs, and various kinds of data. Within or outside the management and calculation processor 100, the management and calculation processor 100 may include, as an auxiliary storage apparatus, another storage apparatus such as a flash memory or an SSD.

The network adapter 106 is a communication interface to be coupled to the network 20. The management and calculation processor 100 further includes a communication interface (an illustration thereof is omitted) to be coupled to the management network within the calculation system.

Here, the individual calculation processors are each realized by the same hardware as that of the management and calculation processor 100.

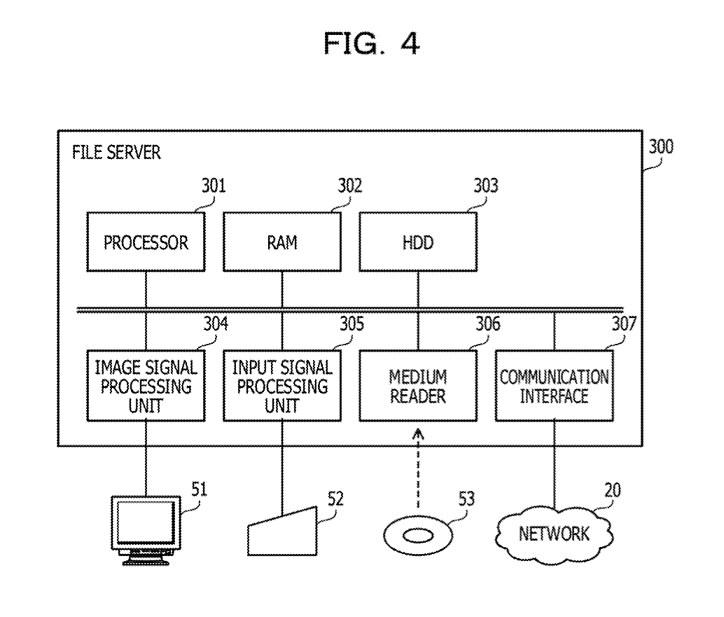

FIG. 4 is a diagram illustrating an example of hardware of a file server. The file server 300 includes a processor 301, a RAM 302, an HDD 303, an image signal processing unit 304, an input signal processing unit 305, a medium reader 306, and a communication interface 307. The individual units are coupled to a bus of the file server 300. In addition, in the same way as the management and calculation processor, the file server 300 includes the interconnect adapter 103 (an illustration thereof is omitted in FIG. 4), in some cases.

The processor 301 controls the entire server 300. The processor 301 may be a multiprocessor including a plurality of processing elements. The processor 301 is a CPU, a DSP, an ASIC, an FPGA, or the like, for example. In addition, the processor 301 may be a combination of two or more elements out of the CPU, the DSP, the ASIC, the FPGA, and so forth.

The RAM 302 is a main storage apparatus of the server 300. The RAM 302 temporarily stores therein at least some of an OS program to be executed by the processor 301 and application programs. In addition, the RAM 302 stores therein various kinds of data to be used for processing performed by the processor 301.

The HDD 303 is an auxiliary storage apparatus of the server 300. The HDD 303 stores therein the OS program, the application programs, and various kinds of data. The server 300 may include another type of auxiliary storage apparatus such as a flash memory or an SSD or may include a plurality of auxiliary storage apparatuses.

In accordance with an instruction from the processor 301, the image signal processing unit 304 outputs an image to a display 51 coupled to the server 300. As the display 51, various kinds of displays such as a cathode ray tube (CRT) display, a liquid crystal display (LCD), and an organic electro-luminescence (EL) display may be used.

The input signal processing unit 305 acquires an input signal from an input device 52 coupled to the server 300 and outputs the input signal to the processor 301. As the input device 52, various kinds of input devices including a pointing device such as a mouse or a touch panel, a keyboard, and so forth may be used. A plurality of types of input device may be coupled to the server 300.

The medium reader 306 is an apparatus to read programs and data recorded in a recording medium 53. As the recording medium 53, magnetic disks such as a flexible disk (FD) and an HDD, optical disks such as a Compact Disc (CD) and a Digital Versatile Disc (DVD), and a magneto-optical disk (MO) may be used, for example. In addition, as the recording medium 53, non-volatile semiconductor memories such as, for example, a flash memory card may be used. In accordance with an instruction from the processor 301, the medium reader 306 stores, in the RAM 302 or the HDD 303, programs and data read from the recording medium 53, for example.

The communication interface 307 performs communication with another apparatus via the network 20.

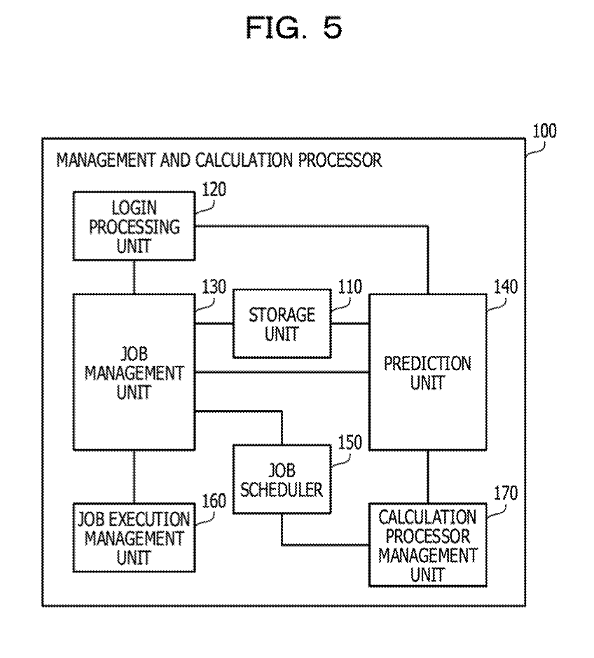

FIG. 5 is a diagram illustrating an example of a function of the management and calculation processor. The management and calculation processor 100 includes a storage unit 110, a login processing unit 120, a job management unit 130, a prediction unit 140, a job scheduler 150, a job execution management unit 160, and a calculation processor management unit 170. The storage unit 110 is realized by a storage area reserved in the RAM 102 or the disk apparatus 40. The processor 101 executes a program stored in the RAM 102, thereby realizing the login processing unit 120, the job management unit 130, the prediction unit 140, the job scheduler 150, the job execution management unit 160, and the calculation processor management unit 170.

The storage unit 110 stores therein information used for processing operations performed by the respective units in the management and calculation processor 100. Specifically, the storage unit 110 stores therein logs related to events such as a login of a user and submitting, execution start, and execution exit of a job, which occur in the management and calculation processor 100. In addition, the storage unit 110 stores therein information used for learning and prediction of demand for calculation processors, performed by the management and calculation processor 100, information of schedules for controlling activation states of the respective calculation processors, and so forth.

The login processing unit 120 receives a user identifier (ID) and a password and collates these with user IDs and passwords preliminarily registered in the storage unit 110, thereby performing login processing of a user. Upon succeeding in a login, the login processing unit 120 notifies the prediction unit 140 of login information including the user ID. In addition, the login processing unit 120 stores a login history in the storage unit 110. The login history includes information of the user ID, which logs in, and a login time thereof.

Furthermore, the login processing unit 120 notifies the prediction unit 140 that the user logs in.

The job management unit 130 receives submitting of a job, performed by the user who logs in. Upon receiving the submitting of a job from the user who logs in, the job management unit 130 notifies the prediction unit 140 that the job is submitted. The job management unit 130 asks the job scheduler 150 to schedule the submitted job. The job management unit 130 asks the job execution management unit 160 to start executing the job by using calculation processors specified by a scheduling result of the job scheduler 150. The job management unit 130 causes the job to be executed by calculation processors. Upon receiving, from the job execution management unit 160, a notification to the effect that execution of the job is exited, the job management unit 130 notifies the prediction unit 140 that the job is exited.

The job management unit 130 stores, in the storage unit 110, a job history including submitting of the job, start of execution of the job, exiting of the job, and so forth. The job history includes the job ID of the relevant job, a time, the number of calculation processors used for the execution of the job, the user ID of a user who asks for processing, and an exit code output as an execution result of the job.

Upon receiving, from the job management unit 130, a notification of submitting of a job, the prediction unit 140 learns demand for calculation processors for each of users, in accordance with execution states of current jobs. The prediction unit 140 performs supervised learning based on the neural network. The prediction unit 140 stores, in the storage unit 110, learning results based on the neural network while associating the learning results with respective user IDs.

In addition, upon receiving login information from the login processing unit 120 or job exit information from the job management unit 130, the prediction unit 140 predicts a predicted time period before submitting of a next job and a necessity number of calculation processors of the next job, by using the learning results stored in the storage unit 110 and based on the neural network. The prediction unit 140 defines, as a predicted time of submitting the next job, a time obtained by adding, to a current time, the predicted time period before submitting of the next job. The prediction unit 140 notifies the calculation processor management unit 170 of prediction results of a necessity number of calculation processors of the next job and the predicted time of submitting.

Upon receiving, from the job management unit 130, a request to schedule the submitted job, the job scheduler 150 performs scheduling of the job and responds to the job management unit 130 with a scheduling result. The job scheduler 150 further plays a function of providing, to the calculation processor management unit 170, information of a schedule for using calculation processors.

The job execution management unit 160 manages execution of the job, which uses the calculation processors specified by the job management unit 130. The job execution management unit 160 acquires, from the storage unit 110, information desired for execution, such as a specified path of an application of the job, arranges the information in corresponding calculation processors, and transmits a command to execute the job to the corresponding calculation processors, thereby causing the individual calculation processors to start executing the job, for example. Upon receiving, from the calculation processors, respective pieces of job exit information (including the above-mentioned exit codes) each indicating that job execution is exited, the job execution management unit 160 notifies the job management unit 130 of the pieces of job exit information.

The calculation processor management unit 170 manages power-supply states of the respective calculation processors, such as power-on or power-off states and suspended states. The calculation processor management unit 170 acquires, as a prediction result based on the prediction unit 140, a necessity number of calculation processors of the next job and the predicted time of submitting. The calculation processor management unit 170 acquires, from the job scheduler 150, information of a schedule for using calculation processors and calculates the number of calculation processors to be used by all jobs at the predicted time of submitting. The calculation processor management unit 170 considers the number of calculation processors currently put into power-on states and determines whether or not calculation processors are insufficient at the predicted time of submitting. In a case of being insufficient, the calculation processor management unit 170 determines that calculation processors put into power-off or suspended states are to be re-energized. In addition, the calculation processor management unit 170 starts activating calculation processors corresponding to a shortage, at a time obtained by subtracting, from the predicted time of submitting, a time taken to activate the calculation processors or to cancel suspended states. In a case where the time obtained by the subtraction is earlier than a current time, the calculation processor management unit 170 immediately starts activating the calculation processors corresponding to the shortage.

In addition, under a predetermined condition, the calculation processor management unit 170 switches each of calculation processors from a power-on state to a power-off state or from a power-on state to a suspended state, thereby achieving low power consumption, in some cases. The calculation processor management unit 170 may switch a calculation processor, used for no arithmetic processing during a predetermined time period, from a power-on state to a power-off state (or to a suspended state), for example.

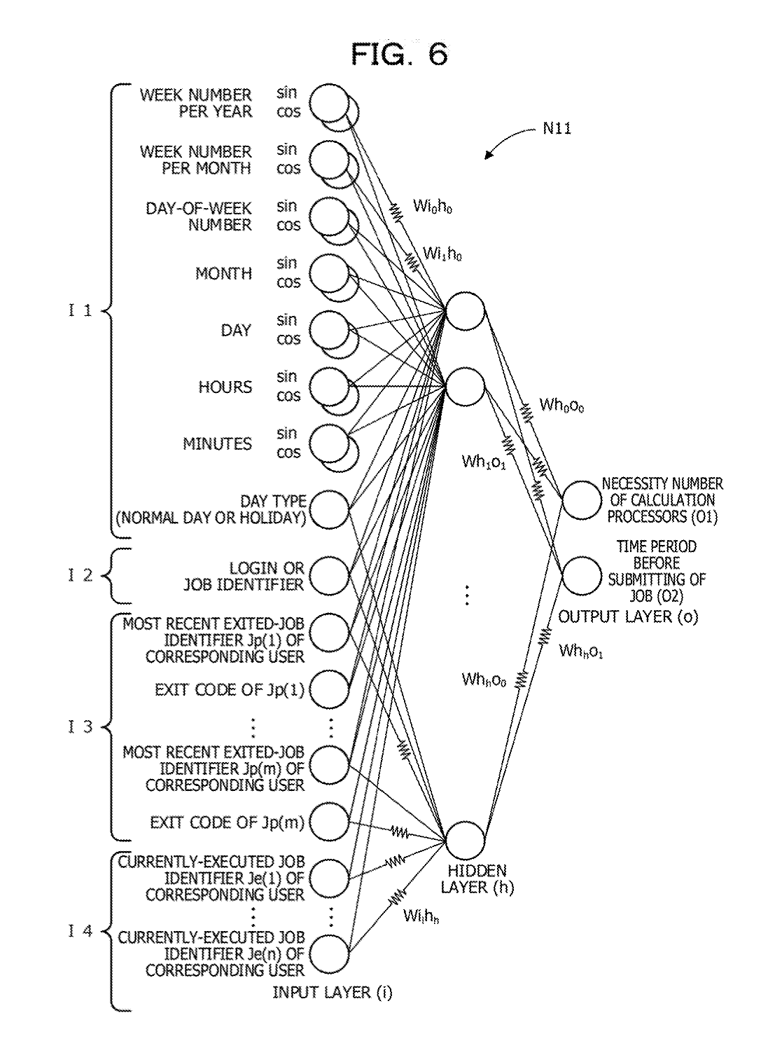

FIG. 6 is a diagram illustrating an example of a neural network. Information of the neural network N11 is stored in the storage unit 110. The neural network N11 includes three layers and is used for supervised machine learning based on the prediction unit 140. A first layer is the input layer. A second layer is the hidden layer. A third layer is the output layer. In this regard, however, the prediction unit 140 may use a neural network including four or more layers in which a plurality of hidden layers are located between the input layer and the output layer. For the learning using the neural network N11, pieces of input-side teacher data I1, I2, I3, and I4 and pieces of output-side teacher data O1 and O2 are used.

The input-side teacher data I1 is time information at a timing of a login or at a timing of exiting of a job and includes a plurality of data elements related to a time (the timing of a login or the timing of exiting of a job turns out to indicate a current time at a timing of performing prediction). Specifically, the input-side teacher data I1 includes information of a week number per year, a week number per month, a day-of-week number, a month, a day, hours, minutes, and a day type (indicating a normal day (a day other than holidays) or a holiday). Here, in a case of using a usual time expression for information related to a time, it is difficult to detect periodicity. It is difficult for “year” information to express periodicity, for example. In addition, while pieces of information such as “month”, “day”, and “time” each have periodicity, it is difficult for the neural network to recognize that 59 minutes and zero minutes are continuous with each other. Therefore, a maximum value and a minimum value of each of pieces of information that express a time are normalized by 2π, and each of the pieces of information is expressed by two values obtained by substituting it into a sine function and a cosine function. In this case, the input-side teacher data I1 turns out to include eight types of data element in total.

The input-side teacher data I2 is information for identifying whether the type of an event is a login or job exit and for identifying a corresponding one of jobs in a case of the job exit. Here, a job ID usually used in, for example, the calculation system is a temporary value in some cases. Therefore, the prediction unit 140 generates an identifier able to continuously differentiate a job. It is conceivable that the prediction unit 140 uses, as an identifier of a job, a hash value of an object program executed as the job, for example. Note that a value range of the hash value (the identifier of the job) is too wide for one unit (one data element) of the neural network N11, in some cases. In that case, a plurality of input units may be provided for one hash value and may be divided into respective digits or the like, and the hash value may be input thereto. In addition, a special value (set to “0”, for example) is preliminarily set for an event of a login.

The input-side teacher data I3 corresponds to identifiers (called exited-job identifiers Jp) of a plurality of jobs of a corresponding one of users, execution of the jobs being most recently existed, and exit codes of the relevant jobs. In this regard, however, the input-side teacher data I3 may correspond to an identifier of one job and an exit code of the relevant job. Here, it is assumed that an exited-job identifier of a job the job exit of which is the earliest is Jp(1). The input-side teacher data I3 includes m exited-job identifiers (m is an integer greater than or equal to one) and exit codes corresponding to the respective m exited-job identifiers, for example. The value of “m” is preliminarily in the storage unit 110, for example. In FIG. 6, the exited-job identifier Jp(1) is a first exited-job identifier (corresponding to a job the job exit of which is the earliest among the m exited jobs). An exited-job identifier Jp(m) is an m-th exited-job identifier (corresponding to a job the job exit of which is the latest among the m exited jobs). The prediction unit 140 inputs “0” to an input unit to which no exited-job identifier is input.

The prediction unit 140 is able to collect, from the job history stored in the storage unit 110, information corresponding to the input-side teacher data 13. The neural network N11 includes a plurality of input units for inputting a plurality of pieces of information. In addition, unit numbers having an ascending order are assigned to the respective input unit. In ascending order of the unit numbers, the prediction unit 140 allocates, to the individual input units, information sequentially from the earliest job exit (in this regard, however, a reverse order may be applied), for example. In addition, the prediction unit 140 allocates the exit codes of respective jobs to respective input units in the same order as that of the identifiers of the respective jobs.

The input-side teacher data I4 corresponds to identifiers (called submitted-job identifiers Je) of currently submitted jobs of a corresponding one of users. Here, each of the job identifiers is not a temporary job ID and is a continuously fixed value such as the hash value explained in the input information I2. In consideration of execution of a plurality of jobs, a plurality of input units are prepared for the neural network N11 (in this regard, however, one input unit may be prepared therefor). In a case where the number of submitted jobs is less than the number of input units, the prediction unit 140 input “0” to surplus input units. In ascending order of the unit numbers of input units, the prediction unit 140 inputs submitted-job identifiers sequentially from the earliest submitting time. The input-side teacher data I4 includes n submitted-job identifiers (n is an integer greater than or equal to “1”), for example. The value of “n” is preliminarily in the storage unit 110, for example. In FIG. 6, a submitted-job identifier Je(1) is a first submitted-job identifier (corresponding to a job the job submit of which is the earliest among the n submitted jobs). An submitted-job identifier Je(n) is an n-th submitted-job identifier (corresponding to a job the job submit of which is the latest among the n submitted jobs).

The output-side teacher data O1 is the number of calculation processors used by actually submitted jobs. The prediction unit 140 is able to acquire the relevant number of calculation processors from the job management unit 130 or the job history.

The output-side teacher data O2 is a time difference (relative time) between a time of occurrence of an event (a login of a corresponding one of users or job exit of the corresponding one of users) immediately preceding a submitted job and a submitting time of the job submitted this time. By referencing the login history and the job history, the prediction unit 140 is able to determine whether the immediately preceding event is the login of the corresponding one of users or the job exit thereof, thereby obtaining a time of occurrence of the relevant event.

Here, it is assumed that the input layer of the neural network N11 has i data elements (input units) in total. The hidden layer of the neural network N11 has h data elements in total. Each of the data elements of the hidden layer is an output of a predetermined function having inputs that are the respective data elements of the input layer. Each of the functions in the hidden layer includes coupling factors (may be called weights) corresponding to the respective data elements of the input layer. The input layer is indicated by a symbol “i”, and the hidden layer is indicated by a symbol “h”, for example. Then, a coupling factor of a zeroth data element of the input layer corresponding to a zeroth data element of the hidden layer is able to be expressed as “Wi₀h₀”. In addition, a coupling factor of a first data element of the input layer corresponding to the zeroth data element of the hidden layer is able to be expressed as “Wi₁h₀”. In addition, a coupling factor of an i-th data element of the input layer corresponding to an h-th data element of the hidden layer is able to be expressed as “Wiᵢhₕ”.

In addition, the output layer of the neural network N11 includes two data elements (output units). Each of the data element of the output layer is an output of a predetermined function having inputs that are the respective data elements of the hidden layer. Each of the functions in the out layer includes coupling factors (weights) corresponding to the respective data elements of the hidden layer. The output layer is indicated by a symbol “o”, for example. Then, a coupling factor of the zeroth data element of the hidden layer corresponding to a zeroth data element of the output layer is able to be expressed as “Wh₀o₀”. A coupling factor of a first data element of the hidden layer corresponding to a first data element of the output layer is able to be expressed as “Wh₁o₀”. A coupling factor of the h-th data element of the hidden layer corresponding to the zeroth data element of the output layer is able to be expressed as “Whₕo₀”. A coupling factor of the h-th data element of the hidden layer corresponding to the first data element of the output layer is able to be expressed as “Whₕo₁”. Based on the supervised learning, the prediction unit 140 updates the above-mentioned individual coupling factors, thereby improving the accuracy of a prediction of demand for calculation processors.

Information (functions, coupling factors, and so forth used for conversion of data elements between layers, for example) of the neural network N11 is stored in the storage unit 110. In addition, the neural network N11 is installed for each of users who use the calculation system of the second embodiment. In other words, upon receiving submitting of a job, performed by one of the users, the prediction unit 140 performs learning based on the neural network N11, by using a history (the job history) of execution of jobs requested by the relevant user and a history (the login history) of logins of the relevant user. For each of the users, the prediction unit 140 stores, in the storage unit 110, a learning result based on the neural network N11.

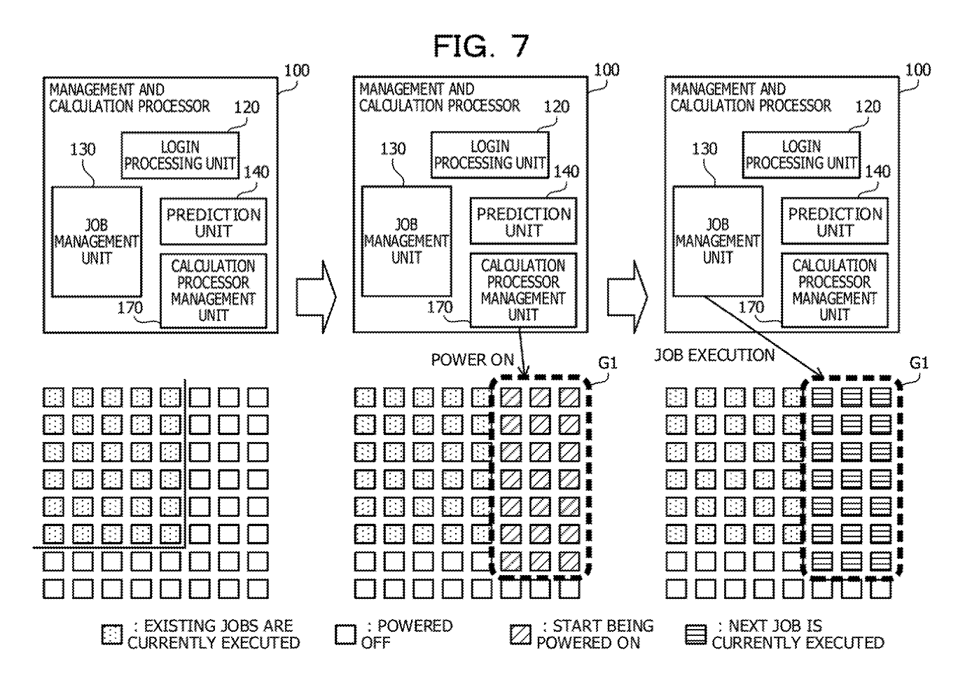

FIG. 7 is a diagram illustrating examples of power activation of calculation processors and execution of jobs. In an example of FIG. 7, quadrangles arranged in a matrix in a plane indicate respective calculation processors. The example of FIG. 7 illustrates eight quadrangles in a longitudinal direction and eight quadrangles in a lateral direction and illustrates 8×8=64 calculation processors. In addition, in FIG. 7, illustrations of the storage unit 110, the job scheduler 150, and the job execution management unit 160 out of functions of the management and calculation processor 100 are omitted. Note that the example of FIG. 7 exemplifies a case where one of the users logs in to the management and calculation processor 100.

First, in an initial stage, 6×5=30 calculation processors currently execute existing jobs, and the 34 remaining calculation processors are in power-off states (may be in suspended states) in order to save power.

In a second stage, one of the users logs in to the management and calculation processor 100. Then, the login processing unit 120 notifies the prediction unit 140 of login information. By using a learning result based on the neural network N11, the prediction unit 140 predicts a time period (a predicted time period before submitting) before submitting of a next job, performed by the relevant user, after the login and a necessity number of calculation processors of the next job. In addition, based on a current time and the predicted time period before submitting, the prediction unit 140 obtains a predicted time of submitting the next job. Based on a prediction result based on the prediction unit 140, the calculation processor management unit 170 obtains the number of missing calculation processors at the relevant predicted time. In addition, based on the predicted time of submitting, the calculation processor management unit 170 considers a time taken to activate calculation processors corresponding to the missing calculation processors, thereby determining a time of activating the calculation processors corresponding to the missing calculation processors. When the determined activation time arrives, the calculation processor management unit 170 powers on the calculation processors corresponding to the missing calculation processors. In the example of FIG. 7, the necessity number of calculation processors of the next job is 21, and the number of the missing calculation processors is 21. In this case, the calculation processor management unit 170 switches a calculation processor group G1 including the 21 calculation processor from power-off states to power-on states, for example.

In a third stage, the user who logs in earlier submits a job to the management and calculation processor 100. By using the calculation processor group G1, the job management unit 130 causes execution of the relevant job to be started (via the job execution management unit 160). In this way, the management and calculation processor 100 preliminarily activates the missing calculation processors and prepares so as to be able to use the calculation processors corresponding to the necessity number of calculation processors of the relevant job immediately after submitting of the job, performed by the relevant user.

Next, a processing procedure based on the management and calculation processor 100 will be specifically described.

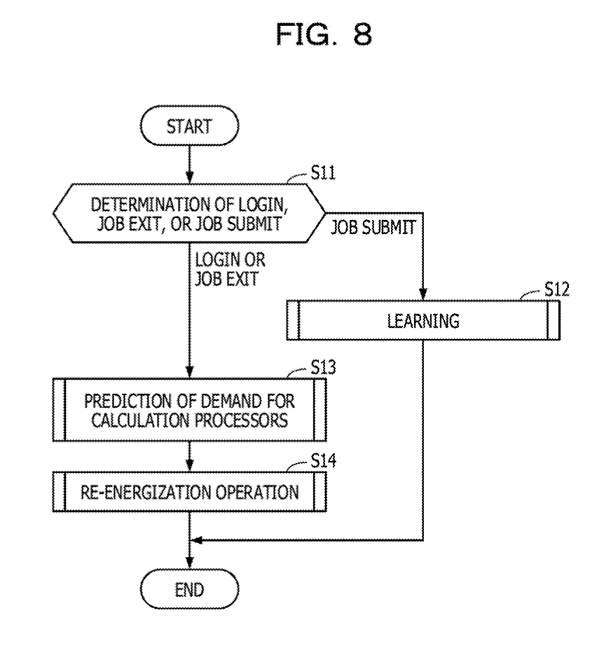

FIG. 8 is a flowchart illustrating an example of processing performed by the management and calculation processor. Hereinafter, the processing illustrated in FIG. 8 will be described in accordance with step numbers.

(S11) The prediction unit 140 determines which of notifications of a login, job exit, and job submit is received. In a case where the notification of job submit is received, the processing is caused to proceed to step S12. In a case where the notification of a login or job exit is received, the processing is caused to proceed to step S13. Here, as described above, the notification of job submit and the notification of job exit are generated by the job management unit 130. The notification of a login is generated by the login processing unit 120.

(S12) The prediction unit 140 performs the supervised learning utilizing the neural network N11. Details of the processing operation will be described later. In addition, the processing is terminated.

(S13) The prediction unit 140 performs a prediction of demand for calculation processors by using a learning result based on the neural network N11. Details of the processing operation will be described later.

(S14) The calculation processor management unit 170 performs a re-energization operation on calculation processors corresponding to missing calculation processors. Details of the processing operation will be described later. In addition, the processing is terminated.

Note that, after execution of step S12 or step S14, the prediction unit 140 waits until a subsequent notification is received. Upon receiving the subsequent notification, step S11 is started again.

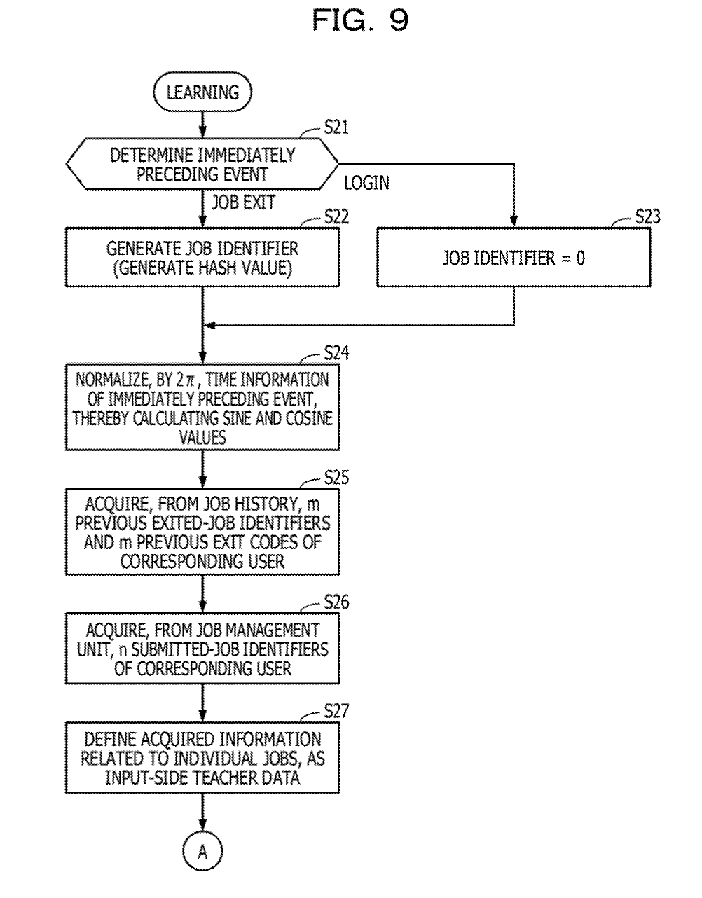

FIG. 9 is a flowchart illustrating an example of learning. Hereinafter, processing illustrated in FIG. 9 will be described in accordance with step numbers. A procedure illustrated as follows corresponds to step S12 in FIG. 8.

(S21) The prediction unit 140 references the login history and the job history stored in the storage unit 110, thereby determining an event immediately preceding submitting of this job, for a user who requests this job. In a case where the immediately preceding event is job exit, the processing is caused to proceed to step S22. In a case where the immediately preceding event is a login, the processing is caused to proceed to step S23. Note that, by only focusing on events of a login or job exit out of events included in the login history or the job history, the prediction unit 140 performs the determination in step S21 (determines an immediately preceding event while taking no account of other events such as start of job execution, for example).

(S22) The prediction unit 140 generates a job identifier of the job submitted this time. Specifically, the prediction unit 140 substitutes an object program of the relevant job into a predetermined hash function, thereby obtaining a hash value, and defines the obtained hash value as the job identifier. In addition, the processing is caused to proceed to step S24. Note that the prediction unit 140 may store, in the storage unit 110, information of a correspondence relationship between job IDs and job identifiers, specified by users (in order to be able to identify the job identifiers with respect to the job IDs recorded in the job history). Alternatively, the job management unit 130 may record, in the job history, job identifiers obtained by the same method as that of the prediction unit 140, as pieces of identification information of respective jobs.

(S23) The prediction unit 140 sets the job identifier to “0” (the job identifier=0). In addition, the processing is caused to proceed to step S24.

(S24) The prediction unit 140 normalizes, by 2π, time information of the immediately preceding event determined in step S21, thereby calculating sine and cosine values.

(S25) The prediction unit 140 acquires, from the job history stored in the storage unit 110, m previous exited-job identifiers and m previous exit codes of the corresponding one of users. Regarding the corresponding one of users, the prediction unit 140 acquires the m most recent exited-job identifiers and the m most recent exit codes for a current time.

(S26) The prediction unit 140 acquires, from the job management unit 130, n submitted-job identifiers of the corresponding one of users.

(S27) The prediction unit 140 defines, as input-side teacher data of the neural network N11, information related to individual jobs and acquired in steps S24 to S26. In addition, the processing is caused to proceed to step S28.

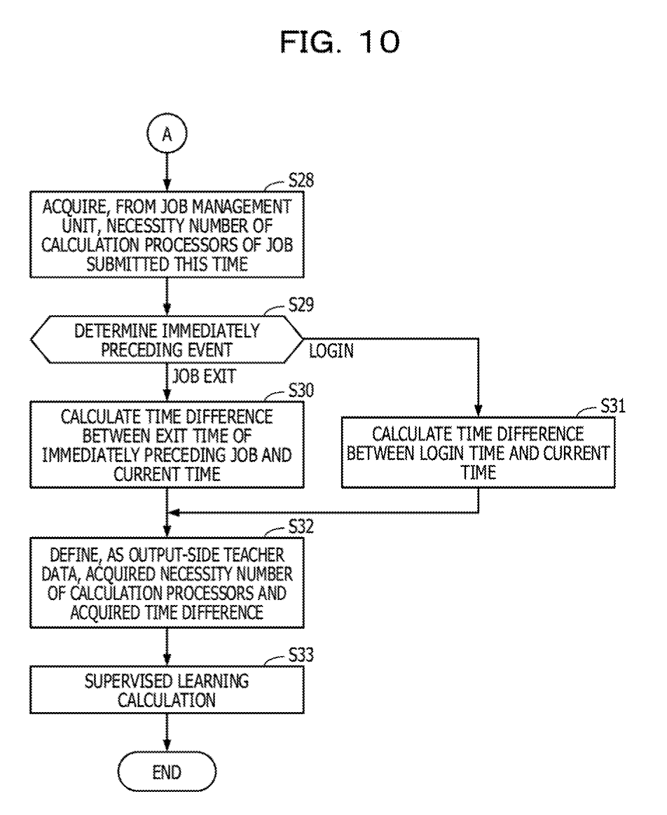

FIG. 10 is a flowchart illustrating the example of the learning (continued). Hereinafter, processing illustrated in FIG. 10 will be described in accordance with step numbers.

(S28) The prediction unit 140 acquires, from the job management unit 130, a necessity number of calculation processors of the job submitted this time.

(S29) The prediction unit 140 references the login history and the job history stored in the storage unit 110, thereby determining an event immediately preceding submitting of this job, for the user who requests this job. In a case where the immediately preceding event is the job exit, the processing is caused to proceed to step S30. In a case where the immediately preceding event is the login, the processing is caused to proceed to step S31. Note that a determination result in step S29 becomes the same as that in step S21. By only focusing on events of a login or job exit out of the events included in the login history or the job history, the prediction unit 140 performs the determination in step S29 (determines an immediately preceding event while taking no account of other events such as start of job execution, for example).

(S30) The prediction unit 140 calculates a time difference between an exit time of the immediately preceding job and the current time. In addition, the processing is caused to proceed to step S32. Note that the prediction unit 140 is able to acquire an exit time of the immediately preceding job from the job history stored in the storage unit 110.

(S31) The prediction unit 140 calculates a time difference between a login time of the corresponding one of users and the current time. Note that the prediction unit 140 is able to acquire the login time of the corresponding one of users, from the login history stored in the storage unit 110. In addition, the processing is caused to proceed to step S32.

(S32) The prediction unit 140 defines, as output-side teacher data of the neural network N11, the necessity number of calculation processors and the time difference acquired in steps S28 to S31.

(S33) The prediction unit 140 performs supervised learning calculation based on the neural network N11. By using an error back propagation method (back propagation), the prediction unit 140 updates individual coupling factors included in the neural network N11, for example. The prediction unit 140 stores, in the storage unit 110, a learning result (the individual updated coupling factors) while associating the learning result with a corresponding one of user IDs.

Note that, in the above-mentioned example, the prediction unit 140 performs learning every submitting of a job. In this regard, however, without being performed every submitting of a job, the learning may be performed after a certain amount of teacher data for the learning is accumulated.

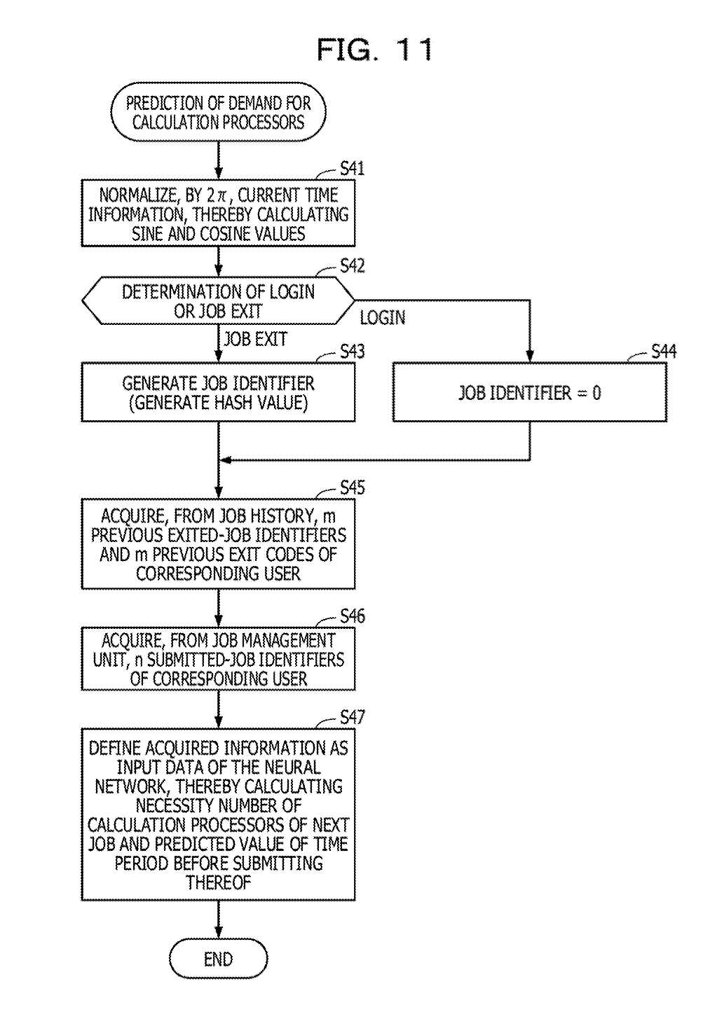

FIG. 11 is a flowchart illustrating an example of a prediction of demand for calculation processors. Hereinafter, processing illustrated in FIG. 11 will be described in accordance with step numbers. A procedure illustrated as follows corresponds to step S13 in FIG. 8.

(S41) The prediction unit 140 normalizes, by 2π, current time information, thereby calculating sine and cosine values.

(S42) The prediction unit 140 determines which of notifications of a login and job exit is received this time. In a case of the job exit, the processing is caused to proceed to step S43. In a case of the login, the processing is caused to proceed to step S44.

(S43) The prediction unit 140 generates a job identifier of a job exited this time. Specifically, the prediction unit 140 substitutes an object program of the relevant job into a predetermined hash function, thereby obtaining a hash value, and defines the obtained hash value as the job identifier. The hash function used in step S43 is the same as the hash function used in step S22. In addition, the processing is caused to proceed to step S45.

(S44) The prediction unit 140 sets the job identifier to “0” (the job identifier=0). In addition, the processing is caused to proceed to step S45.

(S45) The prediction unit 140 acquires, from the job history stored in the storage unit 110, m pervious exited-job identifiers and m pervious exit codes of the corresponding one of users. Regarding the corresponding one of users, the prediction unit 140 acquires the m most recent exited-job identifiers and the m most recent exit codes for the current time.

(S46) The prediction unit 140 acquires, from the job management unit 130, n submitted-job identifiers of the corresponding one of users.

(S47) The prediction unit 140 defines, as input data of the neural network N11, information acquired in steps S41 to S46, thereby calculating a necessity number of calculation processors of a next job based on the corresponding one of users and a predicted value of a time period before submitting thereof. The prediction unit 140 defines, as a predicted time of submitting the next job, a time obtained by adding, to the current time, a prediction of the time period before submitting. Note that, based on the user ID of the corresponding one of users, the prediction unit 140 acquires, from the storage unit 110, information of a learning result of the neural network N11, which corresponds to the corresponding one of users, and is able to use the learning result for the prediction in step S47.

In the neural network N11, the procedures of learning in FIGS. 9 and 10 are repeated, thereby improving the accuracy of a prediction of demand for calculation processors, based on FIG. 11.

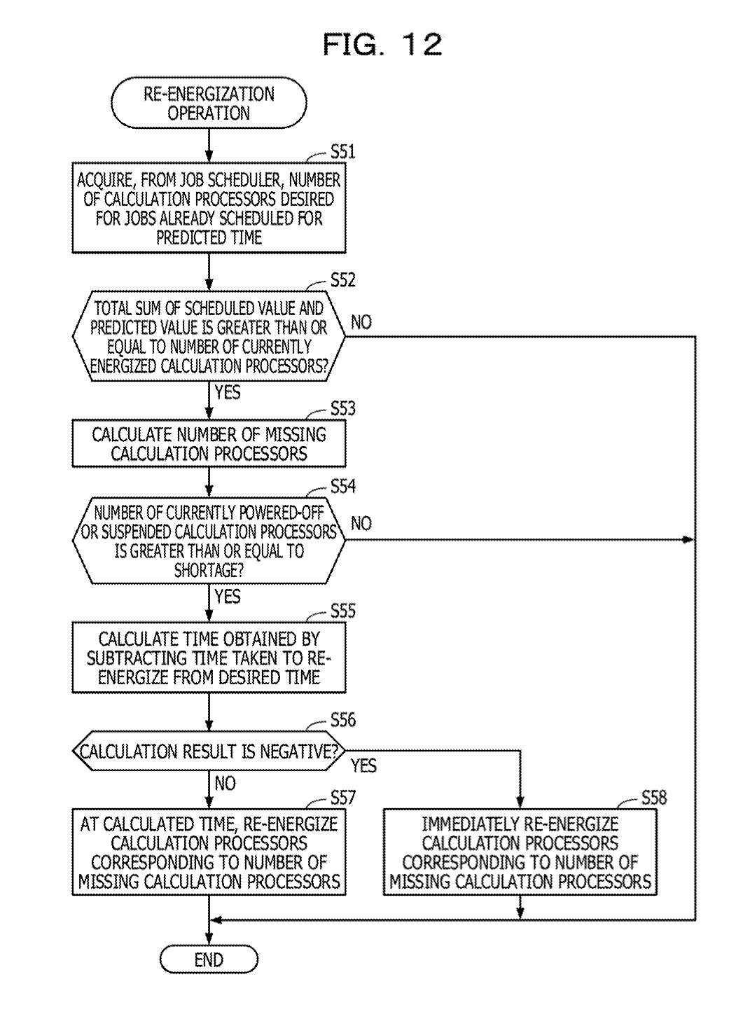

FIG. 12 is a flowchart illustrating an example of a re-energization operation. Hereinafter, processing illustrated in FIG. 12 will be described in accordance with step numbers. A procedure illustrated as follows corresponds to step S14 in FIG. 8.

(S51) The calculation processor management unit 170 acquires, from the job scheduler 150, the number of calculation processors (a scheduled value of the number of calculation processors) desired for jobs already scheduled for the time (the predicted time of submitting), predicted in step S47.

(S52) The calculation processor management unit 170 determines whether or not a total sum of the scheduled value and a predicted value (a predicted value of a necessity number of calculation processors of a next job at the predicted time of submitting) is greater than or equal to the number of currently energized calculation processors. In a case where the total sum of the scheduled value and the predicted value is greater than or equal to the number of currently energized calculation processors, the processing is caused to proceed to step S53. In a case where the total sum of the scheduled value and the predicted value is less than the number of currently energized calculation processors, the processing is terminated. In a case where the total sum of the scheduled value and the predicted value is less than the number of currently energized calculation processors, it becomes possible to secure the number of calculation processors desired at the predicted time, by using the currently energized calculation processors.

(S53) The calculation processor management unit 170 calculates the number of missing calculation processors at the predicted time of submitting. Specifically, the calculation processor management unit 170 defines, as the number of missing calculation processors, a value obtained by subtracting the number of currently energized processors from the total sum of the scheduled value and the predicted value.

(S54) The calculation processor management unit 170 determines whether or not the number of currently powered-off or suspended calculation processors at the present moment is greater than or equal to a shortage (the number of missing calculation processors calculated in step S53). In a case where the number of currently powered-off or suspended calculation processors is greater than or equal to the shortage, the processing is caused to proceed to step S55. In a case where the number of currently powered-off or suspended calculation processors is less than the shortage, the processing is terminated. If the number of currently powered-off or suspended calculation processors is less than the shortage, even in a case where the next job is submitted at the predicted time of submitting, it becomes difficult to start execution of the next job immediately after the predicted time of submitting, under existing conditions (because the number of calculation processors is insufficient for the necessity number of calculation processors).

(S55) The calculation processor management unit 170 calculates a time obtained by subtracting a time taken to re-energize from a desired time (the predicted time of submitting). Regarding currently powered-off or suspended calculation processors, the calculation processor management unit 170 obtains a time taken to re-energize calculation processors the number of which corresponds to the shortage, for example. It is assumed that, due to limitations of power consumption (since a relatively large amount of electric power is consumed for powering on calculation processors, there is a possibility that the power consumption exceeds an upper limit of the power consumption in a case where a large number of calculation processors are simultaneously activated), the number of calculation processors able to simultaneously start being powered on is “N” and the number of missing calculation processors is “M”, for example. In addition, it is assumed that a time taken to activate one calculation processor from a power-off state is τ (in a case of a return from a currently suspended state, it is assumed that τ is a time taken for one calculation processor to make the relevant return). Then, a time taken to re-energize is ROUNDUP (M/N)×τ, for example. The calculation processor management unit 170 calculates a time obtained by subtracting the time taken to re-energize, obtained in this way, from the predicted time of submitting.

(S56) The calculation processor management unit 170 determines whether or not a calculation result in step S55 is negative (in other words, a time earlier than the current time). In a case where the calculation result in step S55 is not negative, the processing is caused to proceed to step S57. In a case where the calculation result in step S55 is negative, the processing is caused to proceed to step S58.

(S57) At the time calculated in step S55, the calculation processor management unit 170 re-energizes calculation processors corresponding to the number of the missing calculation processors calculated in step S53. In addition, the processing is terminated.

(S58) The calculation processor management unit 170 immediately re-energizes the calculation processors corresponding to the number of the missing calculation processors calculated in step S53. In addition, the processing is terminated.

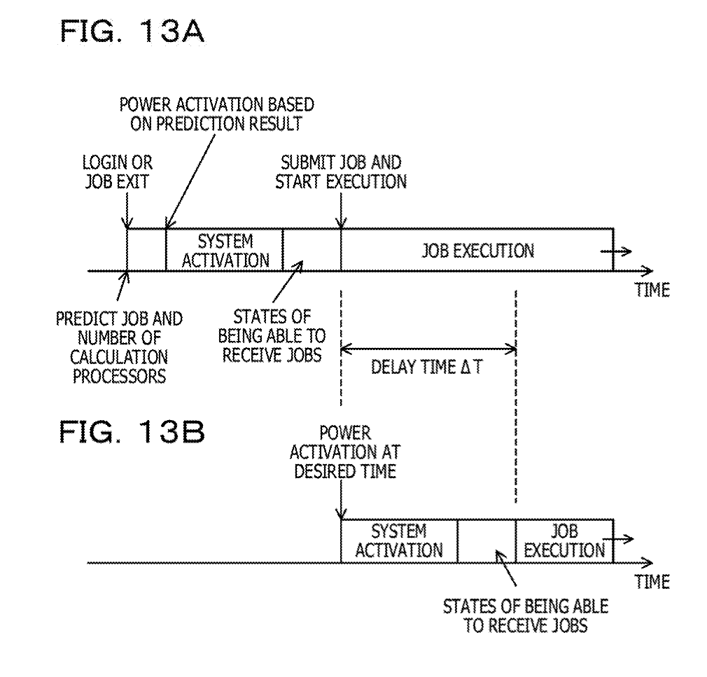

FIGS. 13A and 13B are diagrams each illustrating an example of activation of calculation processors. FIG. 13A illustrates an example of activation of calculation processors, which corresponds to a prediction based on the management and calculation processor 100. FIG. 13B illustrates a comparative example in which power activation is performed at a desired time without using a prediction based on the management and calculation processor 100.

As illustrated in FIG. 13A, upon detecting a login of a user or job exit, the management and calculation processor 100 predicts a predicted time of submitting a next job, based on a corresponding one of users, and a necessity number of calculation processors thereof. In addition, at a time obtained by subtracting, from the predicted time of submitting, which is predicted, a time period obtained by considering a time taken to activate calculation processors, the management and calculation processor 100 performs power activation of calculation processors corresponding to missing calculation processors. Then, within a subsequent time period of system activation, the activation of the calculation processors corresponding to the missing calculation processors is completed. Upon completion of the system activation, the individual activated calculation processors sequentially transition to states of being able to receive jobs. By powering on, in this way, calculation processor in a speculative manner, the management and calculation processor 100 puts, into states of being able to receive jobs, calculation processors corresponding to a predicted necessity number of calculation processors, before the predicted time of submitting. After that, upon submitting of a job, performed by the relevant user, the management and calculation processor 100 is able to immediately start executing the job by using an already activated calculation processor group.

On the other hand, as illustrated in FIG. 13B, it is conceivable that power activation of calculation processors is performed at a timing desired for job execution. However, in this case, during a time period (defined as a delay time ΔT) associated with system activation and transitions to states of being able to receive jobs, it is difficult to start job execution utilizing corresponding calculation processors. In other words, in a case of FIG. 13B, a timing of starting executing the job turns out to be delayed by the delay time ΔT, compared with a case of FIG. 13A.

In an opposite manner, by using the management and calculation processor 100, it is possible to advance starting of execution of the job by the delay time ΔT, compared with the case of the comparative example (FIG. 13B). In this way, in the calculation system of the second embodiment, it is possible to enable execution of the job to be swiftly started.

Here, as exemplified in FIG. 13B, in a case where some of calculation processors are powered off or suspended in order to achieve low power consumption, there is a problem that, as a side effect thereof, it is difficult to immediately use calculation processors at a desired timing to perform calculation. In the calculation system of the second embodiment, there are many operations in each of which a user submits a job at a desired timing. Therefore, when a job is to be submitted and what kind of job is to be submitted are unclear. An operation in which some of calculation processors are powered on at a timing at which a user intends to execute a job is conceivable, for example. However, it takes a time for the calculation processors to be completely powered on after starting being powered on, and the start of execution of the job is delayed. This problem causes a job throughput to be reduced or causes a usage efficiency of a calculation processor to be reduced.

In addition, at a timing of being powered on or at a timing of a return from a suspended state, power consumption is increased compared with a normal time. Therefore, in a case of repeatedly performing re-energization and power-supply disconnection, there is a possibility that power consumption in the calculation system becomes excessive. Therefore, it is conceivable that a prediction of demand for calculation processors is performed, thereby controlling power-on or power-off of calculation processors. However, as described above, when a job is to be submitted to the calculation system and what kind of job is to be submitted thereto are unclear, in some cases.

For a demand prediction, “what kind” does not mean a processing content of the job but means a “necessity number of calculation processors”. For an unsubmitted job, it is not easy to correctly predict whether or not powered-off calculation processors are desired and when and how many calculation processors are desired if the calculation processors are desired. In the calculation system of the second embodiment, after logging in to the management and calculation processor 11, a user inputs a job submit command, thereby asking for job execution. In this case, submitting of a job may have tendencies including a case where a job initially submitted after a login is a specific job, a case where there is an order of submitted jobs, and a case where a job having a specific period is submitted.

If it is possible to detect the tendencies, it is possible to predict “when” and “what kind” of a job is to be subsequently submitted, and there is a chance that it is possible to predict demand for calculation processors. However, users has freedom to select timings of a login and submitting of jobs. Therefore, users each have different tendency, and there is a case where even a same user has a plurality of tendencies and performs selection, depending on states, or the like. In other words, in a case of intending to exhaustively pattern tendencies of users, thereby performing a demand prediction, it is desirable to consider various combinations of conditions, and it is difficult to develop such a prediction program.

Therefore, without programing various combinations of conditions, the management and calculation processor 100 extracts, from login histories and job histories of respective users, pieces of information serving as causes of tendencies and causes the information to be learned based on the machine learning, thereby performing a prediction by using an interpolation function and a generalization function thereof. For this reason, it is possible to roughly predict the number of calculation processors desired for a next job and a submitting timing thereof, and even in a case where power sources of calculation processors are disconnected, it is possible to put calculation processors into states of being able to receive jobs or states close thereto (states in middle of being booted, for example) at a desired timing. Therefore, it is possible to swiftly start executing the next job. In addition, as a result, while reducing power consumption of free calculation processors, it is possible to suppress the reduction of a job throughput or the usage efficiency of resources.

In the example of the second embodiment, it is assumed that the neural network is used as the machine learning mechanism. In this regard, however, it is conceivable that another machine learning mechanism having the supervised learning function and the generalization function is used. As an example of such a machine learning mechanism, a support vector machine (SVM) is cited.

Furthermore, in the example of the second embodiment, it is assumed that the calculation processor management unit 170 determines a timing of performing re-energization of calculation processors. On the other hand, for the relevant determination, it is desirable to comprehensively determine submitted states, waiting states, and execution states of jobs, a maintenance schedule of calculation processors, and so forth, and getting highly complex is conceivable. On the other hand, the job scheduler 150 originally determines these states, thereby scheduling jobs, and it is not a good idea to cause the calculation processor management unit 170 to have the same determination function. Therefore, it is conceivable that a job script of a virtual job having, as a job execution condition, the predicted number of calculation processors is created, thereby causing the job scheduler 150 to perform preliminary scheduling. In that case, the calculation processor management unit 170 is able to re-energize calculation processors in accordance with a scheduling result based on the job scheduler 150.

Note that the information processing of the first embodiment may be realized by causing the management processor 11b to execute a program. In addition, the information processing of the second embodiment may be realized by causing the processor 101 to execute a program. The program may be recorded in the computer-readable recording medium 53. Here, the management and calculation processor 100 may be considered to include a computer including the processor 101 and the RAM 102.

By distributing the recording medium 53 in which the program is recorded, it is possible to distribute the program, for example. In addition, the program may be stored in another computer (the file server 300, for example), and the program may be distributed via a network. The computer may store (install), in a storage apparatus such as the RAM 102 or the disk apparatus 40, the program recorded in the recording medium 53 or the program received from the other computer and may read, from the relevant storage apparatus, and execute the program, for example.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A parallel processing apparatus comprising:
a plurality of calculation processors configured to execute a plurality of jobs;
a memory configured to store information of an executed job before a target job is submitted, an execution exit code of the executed job, the target job, a submitted job before the target job is submitted, and a time difference between a timing of an immediately preceding event of the target job and a timing of submitting the target job; and
a management processor coupled to the memory and configured to:
predict a period to a timing of submitting a next job and a necessity number of the calculation processors for calculating the next job by machine learning mechanism on the basis of the information stored in the memory when an event occurs, and
control each of the calculation processors in accordance with the predicted period and the necessity number of the calculation processors.

2. The parallel processing apparatus according to claim 1, wherein
the information of the executed job, the execution exit code of the executed job, and the information of the submitted job are input-side teacher data of the machine learning mechanism, and
the number of calculation processors used for execution of the submit target job and the time difference are output-side teacher data.

3. The parallel processing apparatus according to claim 2 further comprising:
the input-side teacher data includes information of a time of occurrence of the event.

4. The parallel processing apparatus according to claim 1, wherein
the event is a login of a user, and
the management processor
inputs, at a timing of the login of the user, information of an executed job preceding the timing of the login, an execution exit code of the executed job, and current information of the submitted job, to the machine learning mechanism, and
calculates a time period before submitting of the next job and a necessity number of calculation processors of the next job.

5. The parallel processing apparatus according to claim 1, wherein
the event is exit of one of jobs, and
the management processor
inputs, at a timing of the exit of the one of the jobs, information of an executed job preceding the timing of the exit, an execution exit code of the executed job, and current information of the submitted job, to the machine learning mechanism, and
calculates a time period before submitting of the next job and a necessity number of calculation processors of the next job.

6. The parallel processing apparatus according to claim 1, wherein
the management processor
performs, upon receiving submitting of a job, performed by a user, learning based on the machine learning mechanism, based on a history of execution of jobs requested by the user and a history of logins of the user, and
stores a learning result in a storage unit for each user.

7. The parallel processing apparatus according to claim 1, wherein
the management processor
predicts a time of submitting the next job, based on the predicted time period before the submitting of the next job and a current time,
determines, in accordance with the necessity number of calculation processors and the number of calculation processors already currently activated, the number of calculation processors that are included in calculation processors in powered-off or suspended states and that are to be activated before the predicted time, and
calculates, based on a time taken to activate calculation processors corresponding to the determined number and the predicted time, a time at which activation of calculation processors serving as activation targets is to be started.

8. A job management method for a plurality of calculation processors configured to execute a plurality of jobs stored in a memory configured to store information of an executed job before a target job is submitted, an execution exit code of the executed job, the target job, a submitted job before the target job is submitted, and a time difference between a timing of an immediately preceding event of the target job and a timing of submitting the target job, comprising:
predicting, by a processor, a period to a timing of submitting next job and a necessity number of the calculation processors for calculating the next job by machine learning mechanism on the basis of the information stored in the memory when an event occurs, and
controlling, by a processor, each of the calculation processors in accordance with the predicted period and the necessity number of the calculation processors.
